(19) United States
(12) Patent Application Publication
(10) Pub. No.: US 2023/0108779 A1
(43) Pub. Date: Apr. 6, 2023

(54) ROAD DETERIORATION DIAGNOSTIC DEVICE, ROAD DETERIORATION DIAGNOSTIC SYSTEM, ROADDETERIORATION DIAGNOSTIC METHOD, AND RECORDING MEDIUM

(71) Applicant: NEC Corporation, Minato-ku, Tokyo (JP)

(72) Inventor: Nana JUMONJI, Tokyo (JP)

(21) Appl. No.: 17/908,349

(22) PCT Filed: Mar. 12, 2021
(86) PCT No.: PCT/JP2021/010098

§ 371 Date: Aug. 31, 2022

(30) Foreign Application Priority Data
Mar. 27, 2020 (JP) 2020-058070

(51) Int. Cl. G06T 7/00; G06V 20/56; G06T 7/60; G06T 7/20

(52) U.S. Cl. CPC G06T 7/0002; G06V 20/588; G06T 7/60; G06T 7/20; G06T 2207/30256

(57) ABSTRACT

A road deterioration diagnostic device according to the present disclosure includes: an image information acquisition unit which acquires an image in which a road has been photographed; a puddle detection unit which detects puddles on the basis of the acquired image; and a road deterioration detection unit which detects road deterioration on the basis of the shape of the detected puddles.

### TECHNICAL FIELD

The present disclosure relates to a road deterioration diagnostic device, a road deterioration diagnostic system, a road deterioration diagnostic method, and a recording medium.

### BACKGROUND ART

As a road deterioration diagnostic technique, PTL 1 discloses a method of detecting deterioration of a road surface by measuring unevenness of the road surface by irradiating the road surface with scanning light while traveling on the road with a road surface property measuring vehicle equipped with a laser scanning device.

As another road deterioration diagnostic technique, PTL 2 discloses a method of detecting deterioration of a road surface by combining data of unevenness of the road surface obtained by a laser scanning device and a result of analyzing image data of the road surface captured by an imaging device.

As a related technique, PTL 3 discloses a road deterioration diagnostic technique using an acceleration sensor.

### CITATION LIST

### Patent Literature

[PTL 1] JP 2017-138238 A
[PTL 2] JP 2016-057861 A
[PTL 3] JP 2013-140448 A

### Non Patent Literature

[NPL 1] Jun'ichiro Hayashi, “Image Processing for Advanced Human Life”, Journal of the Japan Society for Precision Engineering vol. 83, No. 10, 2017, pp 928-931

### SUMMARY OF INVENTION

### Technical Problem

In the techniques described in PTLs 1 and 2 described above, use of the laser scanner device makes it possible to accurately measure unevenness of the road surface, but the device is large, a dedicated vehicle is required, and the system becomes very expensive.

An object of the present disclosure is to solve the above-described problem and to provide a road deterioration diagnostic device, a road deterioration diagnostic system, and a road deterioration diagnostic method capable of accurately detecting road deterioration at low cost, and a recording medium.

### Solution to Problem

A first road deterioration diagnostic device according to one aspect of the present disclosure includes: an image information acquisition means configured to acquire an image in which a road is captured; a puddle detection means configured to detect a puddle from the image having been acquired; and a road deterioration detection means configured to detect road deterioration based on a shape of the puddle having been detected.

A second road deterioration diagnostic device according to one aspect of the present disclosure includes: an image information acquisition means configured to acquire an image in which a road is captured; a puddle detection means configured to detect a puddle based on the image having been acquired; and a road deterioration detection means configured to extract a feature amount of the puddle detected from the image and detect road deterioration based on a model for determining a type of road deterioration from a feature amount of a puddle and the feature amount having been extracted.

A road deterioration diagnostic system according to one aspect of the present disclosure includes: the road deterioration diagnostic device according to one aspect of the present disclosure; and an imaging device that transmits, to the road deterioration diagnostic device, the image in which the road is captured.

A road deterioration diagnostic method according to one aspect of the present disclosure includes: acquiring an image in which a road is captured; detecting a puddle based on the image having been acquired; and detecting road deterioration based on a shape of the puddle having been detected.

A computer-readable recording medium according to one aspect of the present disclosure stores a program that causes a computer to execute processing of acquiring an image in which a road is captured; processing of detecting a puddle based on the image having been acquired; and processing of detecting road deterioration based on a shape of the puddle having been detected.

### Advantageous Effects of Invention

An effect of the present disclosure is to be capable of accurately detect road deterioration at low cost.

### BRIEF DESCRIPTION OF DRAWINGS

FIG. 1 is a schematic view illustrating an outline of a road deterioration diagnostic system 10 in a first example embodiment.

FIG. 2 is a block diagram illustrating an example of a configuration of the road deterioration diagnostic system 10 in the first example embodiment.

FIG. 3 is a flowchart presenting road deterioration diagnostic processing in the first example embodiment.

FIG. 4 is a schematic view in a case where a road is captured by a camera in the first example embodiment.

FIG. 5 is a schematic view illustrating an example in which a road region is mapped on a plan view in the first example embodiment.

FIG. 6 is a flowchart presenting details of puddle shape determination processing in the first example embodiment.

FIG. 7 is a schematic view illustrating a shape of a puddle and a determination method of a shape in the first example embodiment.

FIG. 8 is a view illustrating an output example of a determination result in the first example embodiment.

FIG. 9 is a view illustrating an output example of a determination result in the first example embodiment.

FIG. 10 is a block diagram illustrating an example of a configuration of a road deterioration diagnostic system 100 in a second example embodiment.

FIG. 11 is a view illustrating an example of weather information in the second example embodiment.

FIG. 12 is a view illustrating an example of a temporal change in a shape of a puddle in the second example embodiment.

FIG. 13 is a flowchart presenting details of image information acquisition processing in the second example embodiment.

FIG. 14 is a block diagram illustrating an example of a configuration of a road deterioration diagnostic system 110 in a third example embodiment.

FIG. 15 is a table presenting an example of a relationship between IRI and a road deterioration level in the third example embodiment.

FIG. 16 is a view illustrating an output example of a detection result of road deterioration in the third example embodiment.

FIG. 17 is a flowchart presenting road deterioration diagnostic processing in the third example embodiment.

FIG. 18 is a flowchart presenting details of road deterioration level determination processing in the third example embodiment.

FIG. 19 is a block diagram illustrating an example of a configuration of a road deterioration diagnostic system 1 in a fourth example embodiment.

FIG. 20 is a block diagram illustrating an example of a hardware configuration of a computer 500.

### EXAMPLE EMBODIMENT

Example embodiments will be described in detail with reference to the drawings. In each drawing and each example embodiment described in the description, the same components are given the same reference signs, and description is omitted as appropriate.

### First Example Embodiment

The first example embodiment will be described.

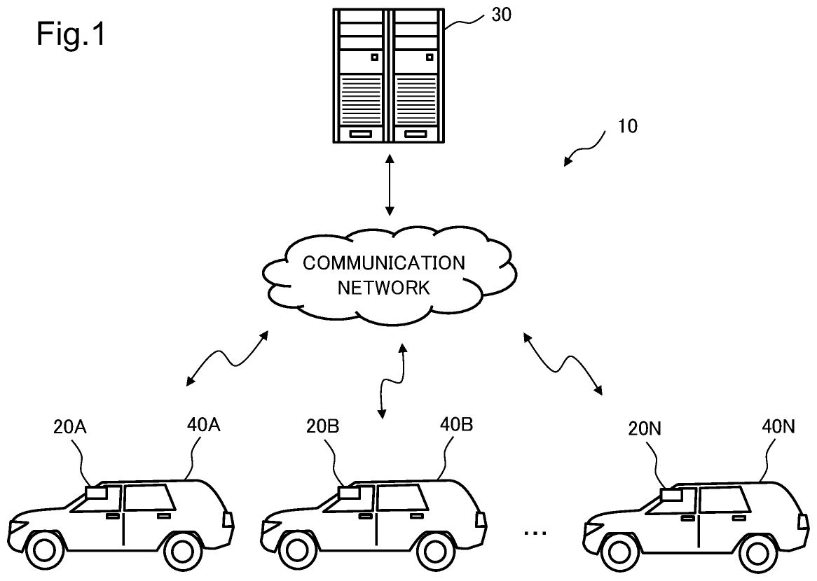

First, the configuration of a road deterioration diagnostic system in the first example embodiment will be described. FIG. 1 is a schematic view illustrating an outline of the road deterioration diagnostic system 10 in the first example embodiment. With reference to FIG. 1, the road deterioration diagnostic system 10 includes a plurality of imaging devices 20A, B, . . . , and N (hereinafter, collectively referred to as imaging device 20), a road deterioration diagnostic device 30, and a plurality of vehicles 40A, B, . . . , and N (hereinafter, collectively referred to as vehicle 40).

In the road deterioration diagnostic system 10, the imaging devices 20A, B, . . . , and N are mounted on respective vehicles 40A, B, . . . , and N belonging to an institution that manages the road such as a local government and a road management company, for example. In the road deterioration diagnostic system 10, the road deterioration diagnostic device 30 and the imaging devices 20A, B, . . . , and N are connected communicably via a communication network, for example.

The road deterioration diagnostic device 30 is disposed in, for example, a road management department of the above-described institution. Note that the road deterioration diagnostic device 30 may be disposed in a place other than the road management department of the above-described institution. In this case, the road deterioration diagnostic device 30 may be achieved by a cloud computing system. The vehicle type of the vehicle 40 is preferably, but not limited to, a vehicle type in which a front hood is short and a road image can be widely captured, such as a van.

Note that in the present example embodiment, a case where the imaging device 20 is mounted on a vehicle will be described. In this case, the imaging device 20 may be, for example, a drive recorder mounted on a vehicle. Furthermore, the imaging device 20 may be mounted on another moving body such as a bicycle or a drone, or a person may carry the imaging device 20.

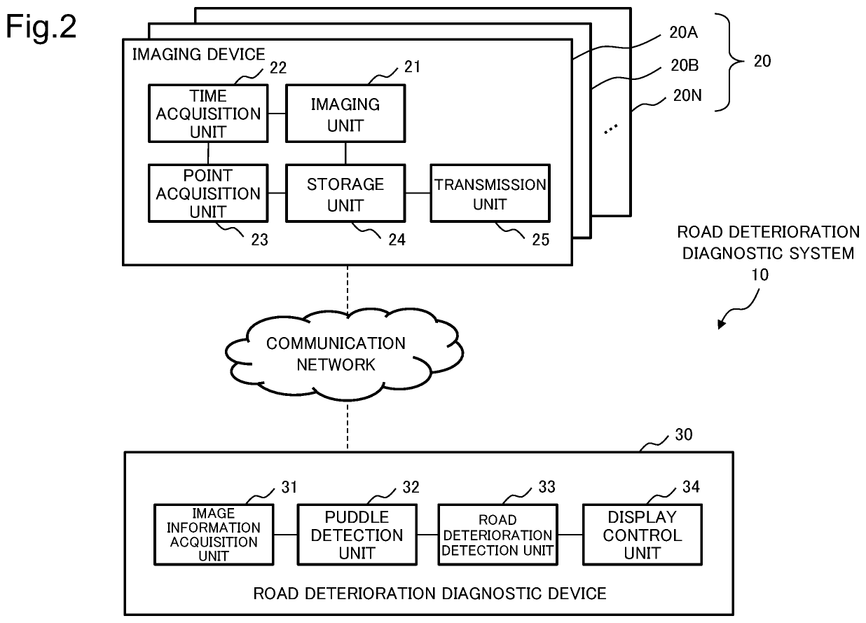

Next, the configuration of each device will be described with reference to FIG. 2. FIG. 2 is a block diagram illustrating an example of the configuration of the road deterioration diagnostic system 10 in the first example embodiment.

(Configuration of Imaging Device)

As illustrated in FIG. 2, the imaging device 20 includes an imaging unit 21, a time acquisition unit 22, a point acquisition unit 23, a storage unit 24, and a transmission unit 25.

The imaging unit 21 captures an image of a road. While the vehicle 40 is traveling on the road, the imaging unit 21 performs imaging at predetermined intervals in such a way as to include the road surface of the road on which the vehicle 40 is traveling.

The time acquisition unit 22 acquires time (hereinafter, also described as capturing time) at which the imaging unit 21 captures an image. The time acquisition unit 22 is configured to associate the capturing time with the image captured by the imaging unit 21 at the capturing time.

The point acquisition unit 23 acquires a point (hereinafter, also referred to as capturing point) captured by the imaging unit 21. The point acquisition unit 23 is configured to associate the capturing point with the image captured by the imaging unit 21 at the capturing point. The point acquisition unit 23 is, for example, a global positioning system (GPS) receiver, and may be included in the imaging unit 21 or may be a separate unit.

The storage unit 24 stores an image captured by the imaging unit 21, and image information including a capturing time and a capturing point associated with the image. The storage unit 24 may be, for example, a random access memory (RAM) or a portable storage medium such as a universal serial bus (USB) memory.

The transmission unit 25 acquires image information from the storage unit 24 and transmits the image information to the road deterioration diagnostic device 30 via the communication network. The transmission of the image information may be, for example, a mode in which the image information of the image is transmitted every time the image is captured, or a mode in which the image information of one or more images captured in each period is transmitted every predetermined period.

When the storage unit 24 is a portable storage medium such as a USB memory, an image in the USB memory may be directly read by the road deterioration diagnostic device 30. In this case, for example, the driver of the vehicle 40 may pass the USB memory storing the image to the operator of the road deterioration diagnostic device 30, and the operator may cause the road deterioration diagnostic device 30 to read the USB memory.

(Configuration of Road Deterioration Diagnostic Device)

The road deterioration diagnostic device 30 includes an image information acquisition unit 31, a puddle detection unit 32, a road deterioration detection unit 33, and a display control unit 34. Some or all of the components of the road deterioration diagnostic device 30 may be achieved by a cloud computing system as described above. For example, the image information acquisition unit 31 may be arranged on a cloud, and the puddle detection unit 32, the road deterioration detection unit 33, and the display control unit 34 may be arranged in a road management department.

The image information acquisition unit 31 receives, via the communication network, image information transmitted from the imaging device 20, and stores the image information in a storage unit not illustrated. The image information acquisition unit 31 acquires image information of a road deterioration diagnosis target from the stored image information. The image information acquisition unit 31 may read (acquire) image information of a road deterioration diagnosis target from a storage medium such as a USB memory.

Based on an image of image information acquired by the image information acquisition unit 31, the puddle detection unit 32 detects a puddle on a road surface included in the image.

The road deterioration detection unit 33 determines the shape of the detected puddle. Here, for example, the road deterioration detection unit 33 determines that the shape of the puddle is “local” or “linear (groove-shaped)”.

In this case, for example, the road deterioration detection unit 33 may calculate a rectangle surrounding the detected puddle (rectangle circumscribing the puddle), and determine the shape of the puddle using the ratio of the length in the long direction to the length in the short direction of the rectangle.

The road deterioration detection unit 33 detects the shape of the puddle according to a ratio x/y of a length x in the long direction and a length y in the short direction of the rectangle surrounding the detected puddle. When the length x in the long direction and the length y in the short direction are not greatly different from each other, that is, when the ratio x/y is less than a predetermined threshold, the road deterioration detection unit 33 may determine that the shape of the detected puddle is local. That is, local means a shape that does not protrude and spread in a certain direction.

when the length x in the long direction and the length y in the short direction are greatly different from each other, that is, when the ratio x/y is equal to or more than the predetermined threshold, the road deterioration detection unit 33 may determine that the shape of the detected puddle is linear (groove-shaped). That is, the linear (groove-shaped) means a shape that protrudes and spreads in a certain direction.

The shape of the puddle may be determined as “local” or “linear (groove-shaped)” by using a predetermined threshold regarding the lengths x and y, in addition to the ratio x/y of the length x in the long direction to the length y in the short direction of the rectangle surrounding the puddle detected by the road deterioration detection unit 33.

The road deterioration detection unit 33 detects road deterioration in accordance with the determination result of the shape of the puddle. Here, for example, the road deterioration detection unit 33 detects a pothole or a rut as a type of road deterioration.

The pothole is a hole having a diameter of about 0.1 to 1 m generated in asphalt on a pavement surface of a road surface. The pothole is formed, for example, as follows. A small crack occurs on the road surface due to frequent traffic jam and excessive traffic. Rainwater or the like permeates through the small crack, and a gap is formed between the asphalt and a sandy ground portion beneath the asphalt. Then, when the gap becomes large, a part of the road collapses due to the weight or impact of passing vehicles, so that the asphalt is peeled off to form a hole.

The rut is a groove-shaped depression formed on the road surface only in a portion through which tires pass. The rut is formed, for example, by asphalt becoming soft at high temperatures in summer and moving so as to flow due to the load of vehicles, or by crushing gaps of the asphalt due to repeated load of vehicles.

In general, it is considered that the deeper the depth of a hole or a depression caused by road deterioration is, the greater the degree of deterioration is. Therefore, a puddle is formed after rainfall in a hole or a depression generated by road deterioration having a large degree of deterioration. When road deterioration is a pothole or a rut, the shape of the puddle becomes a shape characteristic of the pothole or the rut. Therefore, road deterioration such as a pothole or a rut can be detected from the shape of the puddle.

For example, when the shape of the puddle is local, the road deterioration detection unit 33 determines that a pothole has occurred as road deterioration. When the shape of the puddle is linear (groove-shaped), the road deterioration detection unit 33 determines that a rut has occurred as road deterioration.

The display control unit 34 displays a detection result of the image information road deterioration by the road deterioration detection unit 33, for example, via a display.

Next, the operation of the first example embodiment will be described.

(Road Deterioration Diagnostic Processing)

The road deterioration diagnostic processing in the road deterioration diagnostic device 30 will be described.

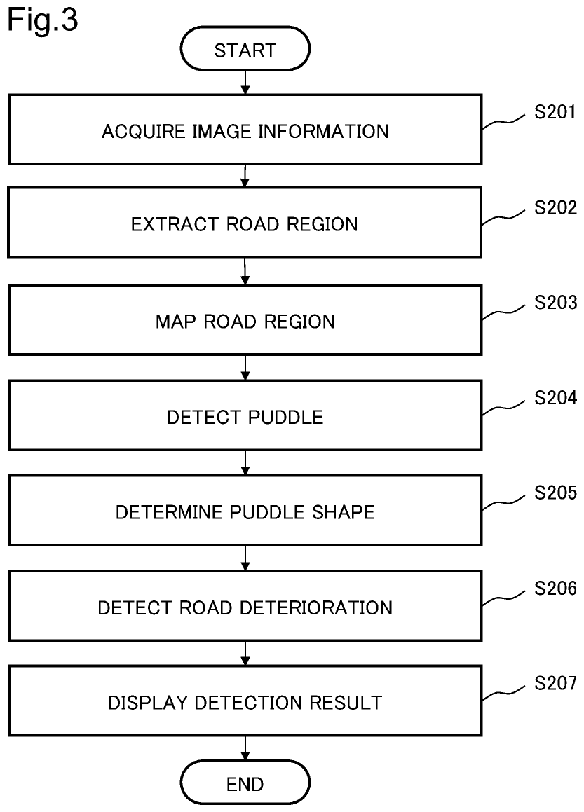

FIG. 3 is a flowchart presenting the road deterioration diagnostic processing in the first example embodiment. The road deterioration diagnostic processing is executed, for example, when an execution instruction for a road deterioration diagnosis is input by an operator or the like after the road deterioration diagnostic device 30 receives image information from the imaging device 20 of each vehicle 40. In the input of the execution instruction, for example, a target point where road deterioration is to be detected is designated.

Note that here, it is assumed that the image information received from the imaging device 20 is stored in a storage unit not illustrated.

The image information acquisition unit 31 acquires image information of a capturing point matching the target point from the storage unit not illustrated (step S201). Note that the image information acquisition unit 31 may acquire an image from a storage unit such as a database not illustrated connected via a communication network. Furthermore, the image information acquisition unit 31 may acquire an image from a storage medium such as a USB memory or an SD card.

The puddle detection unit 32 extracts a road region from an image of image information acquired from the imaging device 20 (step S202). Here, the puddle detection unit 32 detects a road region using, for example, an image recognition technique. In this case, artificial intelligence (AI) that has learned images of road regions by machine learning or deep learning may be used as the image recognition technique. The puddle detection unit 32 may detect the road region by, for example, the Hough transform.

In the Hough transform, for example, in an edge image in which the acquired image has been subjected to edge extraction processing, a straight line passing through each point of the extracted edge is obtained using a distance from an origin that is a predetermined point to each point and an angle from the origin to each point. Then, in the Hough transform, a straight line in the edge image is detected by transforming the straight line passing through each point into a space (parameter space) between the distance and the angle, the space being a parameter representing the straight line of each point, and by calculating a point at which parameters of each straight line match.

The puddle detection unit 32 maps the image of the detected road region onto a plan view of the road surface viewed from above (step S203).

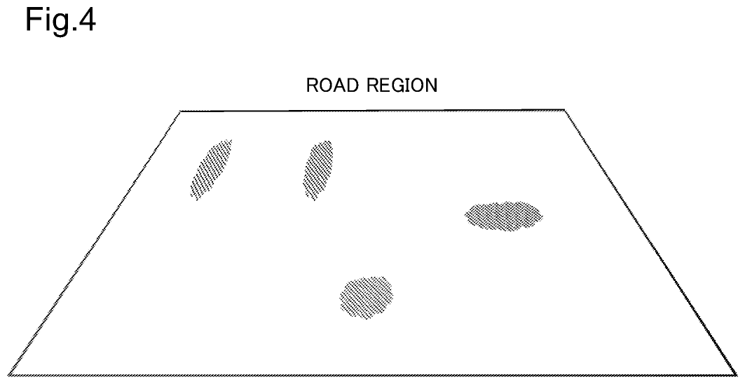

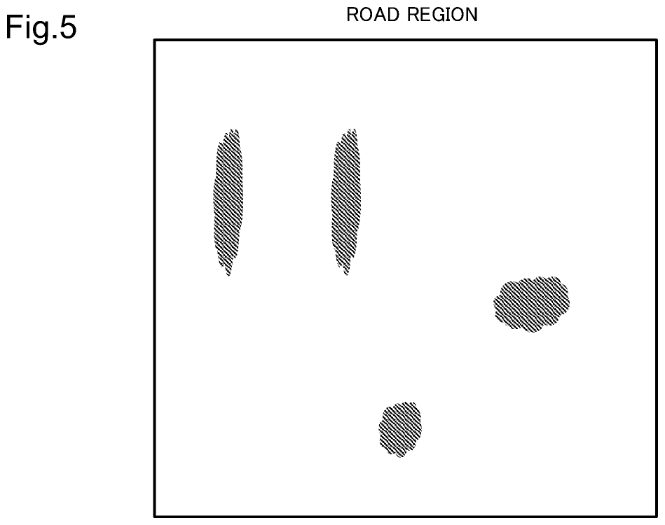

Here, an example of mapping the road region detected by the puddle detection unit 32 onto a plan view will be described with reference to FIGS. 4 and 5.

FIG. 4 is a schematic view in a case where the road is captured by a camera in the first example embodiment. In each of FIG. 4 and subsequent figures, hatched parts indicate puddles or wet parts on the road surface. In general, in a perspective image captured by a camera, even in a straight road where both sides of the road extend in parallel, both sides of the road extend toward a point, that is, a vanishing point. That is, objects of the same size become different in size between on the front side (side close to the vehicle) and on the back side (side far from the vehicle) of the captured image. Therefore, as illustrated in FIG. 4, puddles of the same size appear large on the front side of the captured image and appear small on the back side of the captured image. Therefore, in the present example embodiment, an image of the detected road region is mapped on a plan view as the road surface is viewed from above, and an accurate shape of a puddle is detected.

FIG. 5 is a schematic view illustrating an example in which a road region is mapped on a plan view in the first example embodiment. The mapping method may be, for example, mapping at a magnification at which the width of the road becomes the same as the road width on the frontmost side. The mapping method is not limited to this, and may be performed using a well-known technique.

The puddle detection unit 32 detects a puddle in the extracted road region (step S204). Here, the puddle detection unit 32 detects a puddle on the road region using, for example, an image recognition technique. Also in this case, a learning model that as learned images of puddles by machine learning may be used as the image recognition technique. The puddle detection unit 32 may detect a puddle based on, for example, a difference in the road region between a dry road surface and a road surface with a puddle, that is, a difference in color of the road surface in the road region. The puddle detection unit 32 may determine whether a reflection component is a road surface or a puddle by distinguishing whether the reflection component in the road region in the image is a diffuse reflection component or a specular reflection component. In this case, the puddle detection unit 32 distinguishes between, for example, a reflection component and a specular reflection component by a Laplacian filter as presented in NPL 1, for example. In this method, the reflection components can be distinguished not only in the daytime in which sunlight is available but also in the night using a street light or a vehicle light as a light source.

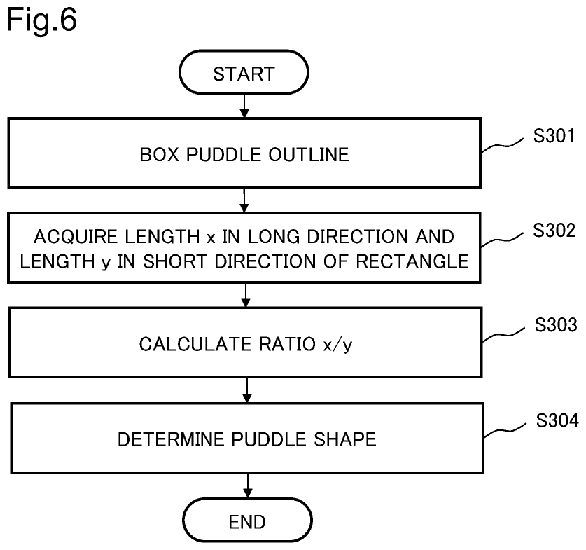

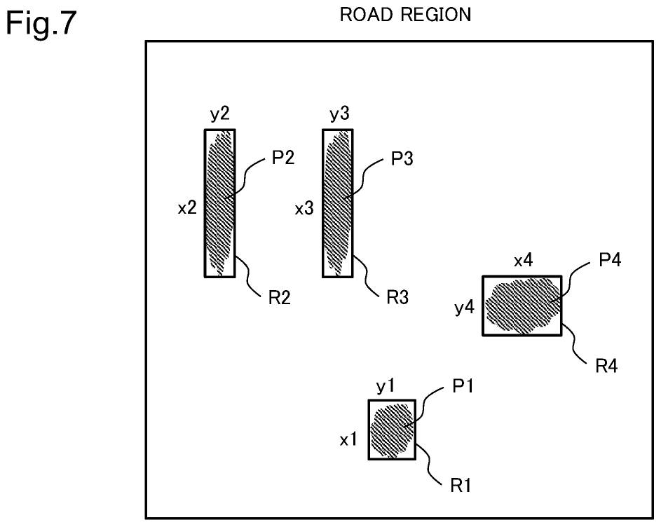

Next, the road deterioration detection unit 33 determines the shape of the detected puddle (step S205). FIG. 6 is a flowchart presenting details of the puddle shape determination processing (step S205) in the first example embodiment. FIG. 7 is a schematic view illustrating the shape of a puddle and a determination method of the shape in the first example embodiment. Note that FIG. 7 illustrates a puddle in the road region mapped in step S203. The road deterioration detection unit 33 performs the following processing on each puddle detected in the road region.

With reference to FIG. 6, the road deterioration detection unit 33 surrounds the detected puddle with a rectangle in contact with the outline of the puddle (step S301). The road deterioration detection unit 33 acquires the length x in the long direction and the length y in the short direction from the rectangle surrounding the detected puddle (step S302). The road deterioration detection unit 33 calculates the ratio x/y from the length x in the long direction and the length y in the short direction having been acquired (step S303).

For example, as illustrated in FIG. 7, the road deterioration detection unit 33 calculates rectangles R1 to R4 surrounding detected puddles P1 to P4. The road deterioration detection unit 33 acquires lengths x1 to x4 in the long direction and lengths y1 to y4 in the short direction for the calculated rectangles R1 to R4, respectively. The road deterioration detection unit 33 obtains ratios x1/y1, x2/y2, x3/y3, and x4/y4 for the puddles P1 to P4, respectively.

The road deterioration detection unit 33 determines whether the shape of the detected puddle is local or linear (groove-shaped) according to the calculated ratio x/y (step S304). Here, the road deterioration detection unit 33 determines that the shape of the puddle is local when the calculated ratio x/y is less than a predetermined threshold. When the calculated ratio x/y is equal to or more than the predetermined threshold, the road deterioration detection unit 33 determines that the shape of the puddle is linear (groove-shaped). In the example illustrated in FIG. 7, the road deterioration detection unit 33 determines that the shape of the puddle P1 is local, and determines that the shapes of the puddles P2 and P3 are linear (groove-shaped).

Next, the road deterioration detection unit 33 detects road deterioration based on the determined shape of the puddle (step S206). Here, when the shape of the puddle is local, the road deterioration detection unit 33 determines that a pothole has occurred at the position of the puddle. When the shape of the puddle is linear (groove-shaped), the road deterioration detection unit 33 determines that a rut has occurred at the position of the puddle. In the example illustrated in FIG. 7, the road deterioration detection unit 33 determines that there is a pothole at the position of the puddle P1, and determines that there are ruts at the positions of the puddles P2 and P3.

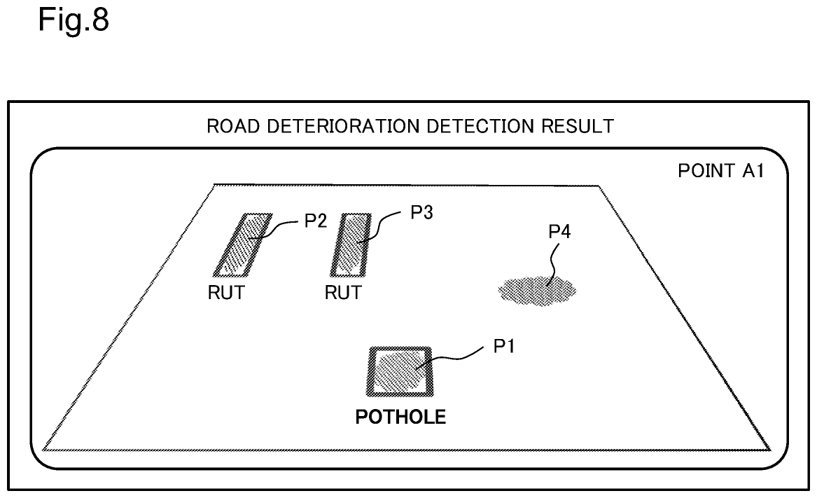

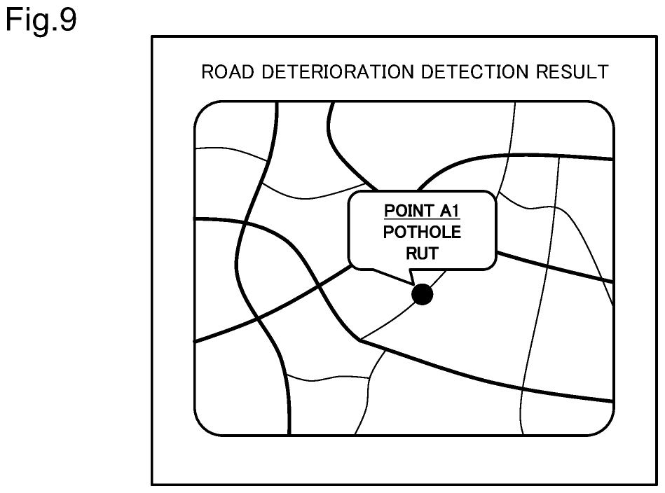

The display control unit 34 displays a detection result of road deterioration on, for example, a display (step S207). FIGS. 8 and 9 are views illustrating a display example of a detection result of road deterioration in the first example embodiment. The display control unit 34 displays, as a detection result, an image indicating the presence of road deterioration at a position of the puddle where the road deterioration is detected in an image in which the road is captured, for example, and the type of the road deterioration. In the example of FIG. 8, the periphery of the puddle P1 determined to be a pothole is emphasized with a rectangular frame indicating road deterioration, and the type “pothole” is written. The peripheries of the puddles P2 and P3 determined to be ruts are also emphasized by rectangular frames, and the type “rut” is written. Furthermore, the display control unit 34 may display, as a detection result, an image indicating the presence of road deterioration at a capturing point of the image where the road deterioration is detected on the map, for example, and the type of the road deterioration. In the example of FIG. 9, a circle indicating road deterioration is given at a point “A1”, where the road deterioration of FIG. 8 is detected, and types “pothole” and “rut” are written around the circle.

Thus, the operation of the first example embodiment is completed.

Note that in the first example embodiment described above, the road region in the image acquired by the image information acquisition unit 31 is mapped on a plan view, and detection of a puddle and detection of road deterioration are performed on the plan view. However, the present disclosure is not limited to this, and detection of a puddle and detection of road deterioration may be performed on an image other than a plan view, such as detection of a puddle and detection of road deterioration performed on an image acquired by the image information acquisition unit 31.

In the first example embodiment, the road deterioration detection unit 33 determines the shape of the puddle by the ratio between the long direction and the short direction of the rectangle surrounding the puddle. However, as long as the shape corresponding to road deterioration can be detected, the shape (local or linear) of a puddle may be determined from an image of the puddle using, for example, a known pattern recognition technique or another method such as AI that has learned the relationship between images of puddles and shapes by machine learning or deep learning. In this case, a shape other than local or linear corresponding to road deterioration other than a pothole and a rut may be determined, and road deterioration other than a pothole and a rut may be detected. When it is determined by pattern recognition or the AI described above that the shape of the puddle is a shape unique to a crack, the crack may be detected as road deterioration. From the image of the puddle, not only the shape (local or linear) of the puddle is determined but also, for example, in the case of a rut, the orientation of the puddle such as the puddle being formed along the lane may be considered. In this case, the orientation of the puddle is the long direction of the puddle.

The road deterioration detection unit 33 may determine the type of road deterioration from an image of a puddle using a road deterioration determination model of AI that has learned the relationship between images of puddles and types of road deterioration by machine learning or deep learning.

The puddle detection unit 32 may determine a puddle from an image acquired from the imaging device 20 using a puddle determination model of AI having learned by machine learning or deep learning using labeled images of puddles as training data.

The road deterioration detection unit 33 may determine a puddle and the type of road deterioration from the image acquired from the imaging device 20 by using a road deterioration determination model of AI having learned by machine learning or deep learning using, as training data, an image added with the presence or absence of a puddle and the type of road deterioration. In this case, the road deterioration detection unit 33 may have a function of the puddle detection unit 32.

In the first example embodiment, road deterioration is detected based on the shape of a puddle. However, the present disclosure is not limited to this, and road deterioration may be detected using an analysis result (hereinafter, also described as analysis result at the time of drying) of an image when the road surface is dry, in addition to the shape of the puddle. In this case, for example, when there is a specific facility or structure such as a handhole or a manhole detected by an analysis result at the time of drying at the position of the detected puddle, the puddle detection unit 32 and the road deterioration detection unit 33 may exclude the puddle from the detection target of road deterioration. This makes it possible to prevent road deterioration from being erroneously detected based on the shape of a puddle formed by a facility or a structure, for example, a local puddle formed by, for example, a handhole, a manhole, or the like is erroneously detected as a pothole, and possible to improve the detection accuracy of road deterioration.

Next, effects of the first example embodiment will be described.

According to the first example embodiment, road deterioration can be accurately detected at low cost. This is because a puddle is detected based on an image in which a road is captured, and road deterioration is detected based on the shape of the detected puddle.

### Second Example Embodiment

The second example embodiment will be described.

The second example embodiment is different from the first example embodiment in that a puddle is detected using an image captured in a specific time period after the end of rainfall.

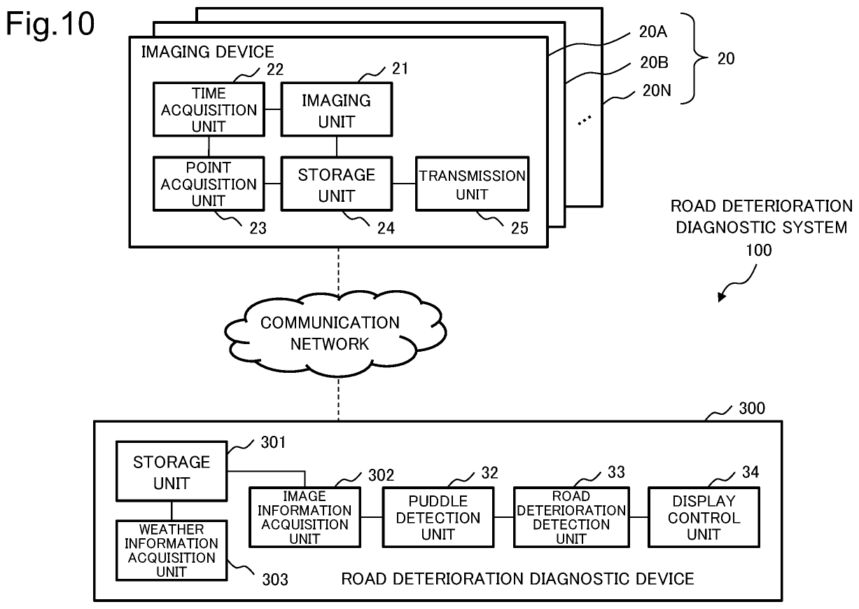

The configuration of a road deterioration diagnostic system according to the second example embodiment will be described. FIG. 10 is a block diagram illustrating an example of the configuration of the road deterioration diagnostic system 100 according to the second example embodiment. In the second example embodiment, parts same as those in the first example embodiment are given by the same reference signs, description is omitted, and only different parts will be described.

(Configuration of Road Deterioration Diagnostic Device)

A road deterioration diagnostic device 300 includes a storage unit 301, an image information acquisition unit 302, a weather information acquisition unit 303, the puddle detection unit 32, the road deterioration detection unit 33, and the display control unit 34.

The storage unit 301 stores image information received from the imaging device 20. The storage unit 301 stores weather information acquired by the weather information acquisition unit 303.

The weather information acquisition unit 303 acquires weather information from an external information source, for example, the Meteorological Agency, a weather site for the Internet, or the like. The weather information acquisition unit 303 stores the acquired weather information in the storage unit 301.

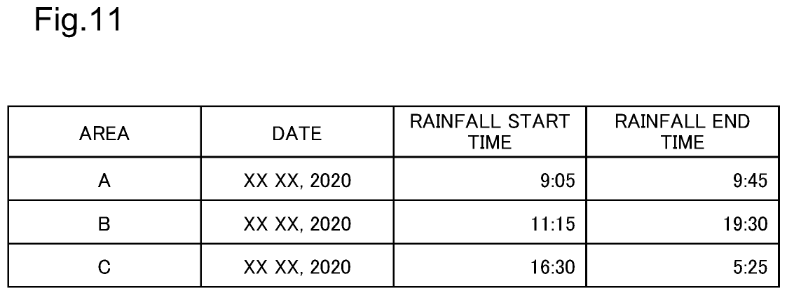

FIG. 11 is a view illustrating an example of weather information in the second example embodiment. As illustrated in FIG. 11, the weather information includes an area and weather for each time segment in the area. The weather information may further include a precipitation amount, temperature, and humidity for each time segment.

Note that the weather information acquisition unit 303 may receive weather information from the imaging device 20 mounted on each vehicle 40. In this case, as weather information, the weather information acquisition unit 303 receives, from the imaging device 20, for example, a traveling point, a traveling time, and weather (presence or absence of rainfall) determined based on the presence or absence of operation of a wiper in the vehicle 40 and output of a raindrop sensor.

The image information acquisition unit 302 acquires image information including an image captured in a specific time period after the end of rainfall from the image information stored in the storage unit 301.

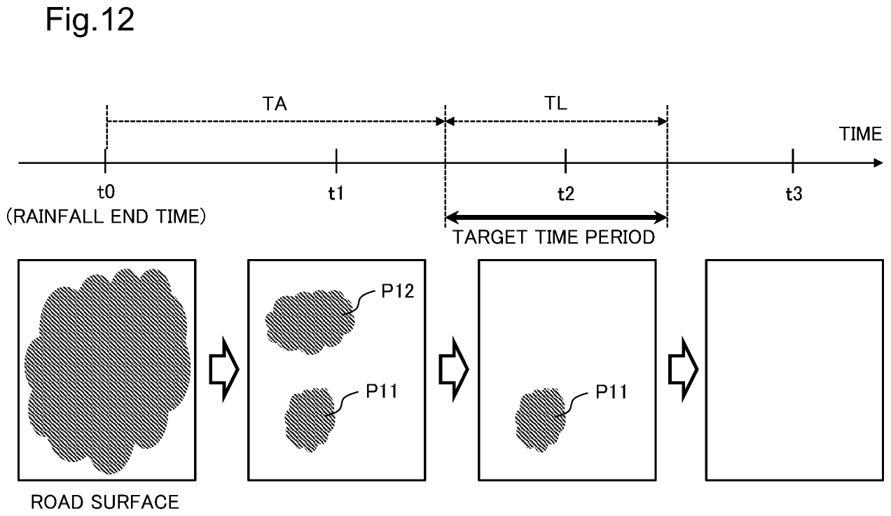

Here, a temporal change in the shape of a puddle after the end of rainfall will be described. FIG. 12 is a view illustrating an example of a temporal change in the shape of a puddle in the second example embodiment. In FIG. 12, a puddle P11 is a deep puddle caused by road deterioration, and a puddle P12 is a shallow puddle caused by not road deterioration but fine unevenness or the like on a normal road surface. That is, the depth of the puddle P11 is deeper than that of the puddle P12.

As illustrated in FIG. 12, since the entire road surface is generally wet at rainfall end time t0, it is difficult to detect a puddle. At time t1 after the rainfall end time, since the part on the road surface other than the puddle dries, the puddle P11 and the puddle P12 appear. Furthermore, at subsequent time t2, shallow puddles dry, and thus the puddle P12 disappears, but the puddle P11 remains. Then, at subsequent time t3, since deep puddles also dry, the puddle P11 also disappears.

Therefore, it is possible to improve detection accuracy by detecting road deterioration using the shape of the puddle detected based on the image captured at time t2.

Here, in consideration of variation at time t2, a time at which it is assumed that a deep puddle caused by road deterioration of the detection target remains and a shallow puddle caused by unevenness that is not road deterioration disappears is designated by a time period (hereinafter, also referred to as target time period). The target time period is designated with, for example, a time TA (predetermined time) and a time length TL (predetermined length) from the rainfall end time.

The time TA and the time length TL for designating the target time period are set in advance by, for example, an operator or the like. Different values may be set to the time TA and the time length TL according to the depth of a depression caused by the road deterioration of the detection target, the temperature and humidity at the target point, the rainfall amount at the time of rainfall, the duration of rainfall, the road surface pavement method, and the like.

The image information acquisition unit 302 refers to the weather information stored in the storage unit 301, and acquires image information in which the capturing point is included in an area having rainfall in the weather information and the capturing time is included in the target time period.

The puddle detection unit 32 detects a puddle based on the image included in the acquired image information similarly to the first example embodiment.

The road deterioration detection unit 33 detects road deterioration based on the detected shape of a puddle similarly to the first example embodiment.

Similarly to the first example embodiment, the display control unit 34 displays a detection result of road deterioration on, for example, a display.

Next, the operation of the second example embodiment will be described.

(Road Deterioration Diagnostic Processing)

The flowchart of the road deterioration diagnostic processing of the second example embodiment becomes similar to the flowchart (FIG. 3) of the road deterioration diagnostic processing of the first example embodiment. However, in the image information acquisition processing (step S201), the following processing is performed.

In the image information acquisition processing (step S201) of the second example embodiment, the image information acquisition unit 302 refers to the weather information, and acquires image information in which the capturing point is included in an area having rainfall in the weather information and the capturing time is included in the target time period.

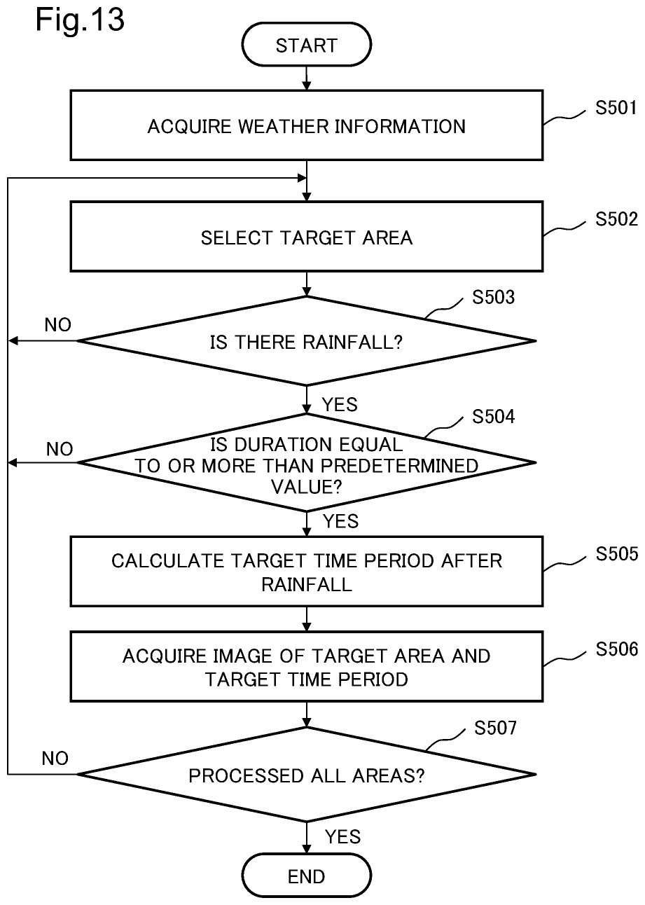

FIG. 13 is a flowchart presenting details of the image information acquisition processing (step S201) in the second example embodiment.

Here, it is assumed that the storage unit 301 stores image information transmitted from the imaging device 20 and weather information acquired by the weather information acquisition unit 303.

The image information acquisition unit 302 acquires weather information from the storage unit 301 (step S501).

The image information acquisition unit 302 selects one area (hereinafter, also referred to as target area) from the acquired weather information (step S502).

The image information acquisition unit 302 determines whether there has been rainfall in the target area (step S503).

When there has been no rainfall (step S503/N0), the processing from step S502 is repeated.

When there has been rainfall (step S503/YES), the image information acquisition unit 302 determines whether the duration of rainfall is equal to or more than a predetermined value (step S504). Here, the image information acquisition unit 302 may determine whether an accumulated rainfall amount in a predetermined period up to the rainfall end time is equal to or more than a predetermined value instead of the duration of rainfall.

When the duration is less than the predetermined value (step S504/NO), the processing from step S502 is repeated.

When the duration is equal to or more than the predetermined value (step S504/YES), the image information acquisition unit 302 calculates a target time period (time period of the time length TL (predetermined length) after the time TA (predetermined time) from the rainfall end time) after rainfall (step S505).

The image information acquisition unit 302 acquires, from the image information stored in storage unit 301, image information in which the capturing point is included in the target area and the capturing time is included in the target time period (step S506).

Thereafter, the processing from step S502 is repeated for all the areas included in the weather information (step S507).

The processing (steps S202 to 207) after the image information acquisition processing (step S201) from when the puddle detection unit 32 extracts a road region to when the display control unit 34 displays a detection result of road deterioration is similar to that in the first example embodiment. Note that these processing are performed on the image information at each capturing time at each capturing point acquired by the image information acquisition unit 302.

Thus, the operation of the second example embodiment is completed.

Next, effects of the second example embodiment will be described.

According to the second example embodiment, road deterioration can be detected more accurately than in the first example embodiment. This is because the road deterioration diagnostic device 300 detects road deterioration based on the shape of a puddle detected from an image captured in a time period (target time period) of a predetermined length after a predetermined time from a rainfall end time at a capturing point having rainfall. By designating a time period in which deep puddles caused by road deterioration remain and shallow puddles not caused by road deterioration disappear as a target time period, it is possible to exclude shallow puddles not caused by road deterioration from the detection target of road deterioration.

### Third Example Embodiment

The third example embodiment will be described.

The third example embodiment is different from the second example embodiment in that a road deterioration level calculated based on acceleration information is output.

In the third example embodiment, vibration (acceleration in the vertical direction) of the vehicle 40 that is capturing an image of a road is measured, an international roughness index (IRI) based on the measurement result (acceleration information) is calculated, and a level of road deterioration based on a puddle detected from the image and the calculated IRI is displayed around the puddle in the image.

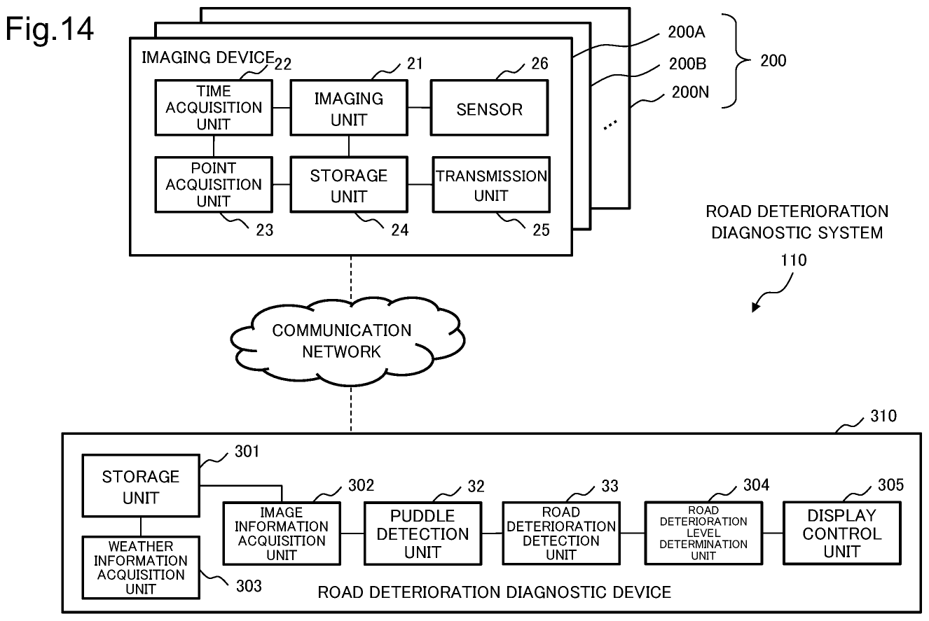

The configuration of a road deterioration diagnostic system according to the third example embodiment will be described. FIG. 14 is a block diagram illustrating an example of the configuration of the road deterioration diagnostic system 110 according to the third example embodiment. In the third example embodiment, parts same as those in the second example embodiment are given by the same reference signs, description is omitted, and only different parts will be described.

(Configuration of Imaging Device)

An imaging device 200 of the third example embodiment further includes a sensor 26 in addition to the configuration of the imaging device 200 of the second example embodiment.

The sensor 26 measures a variation in vertical motion of the vehicle 40. The sensor 26 is, for example, a three-axis acceleration sensor. The sensor 26 generates acceleration information. The acceleration information indicates a variation in vertical motion of the vehicle 40, that is, vibration. The vibration in the vehicle 40 generated with respect to unevenness of the road surface differs depending on the vehicle type of the vehicle 40, aged deterioration, and the like. Therefore, even if the unevenness of the road surface is the same, the acceleration information differs depending on the vehicle 40. Therefore, calibration may be performed such that the acceleration information in the case of traveling on the same unevenness at the same speed, for example, becomes the same regardless of the vehicle 40. The calibration may be performed using another known method.

The transmission unit 25 transmits, to a road deterioration diagnostic device 310, image information including an image captured by the imaging unit 21, a capturing time and a capturing point associated with the image, and acceleration information. The transmitted image information is stored in the storage unit 301 of the road deterioration diagnostic device 310.

(Configuration of Road Deterioration Diagnostic Device)

The road deterioration diagnostic device 310 of the third example embodiment further includes a road deterioration level determination unit 304 in addition to the configuration of the road deterioration diagnostic device 300 of the second example embodiment. A display control unit 305 is included in place of the display control unit 34.

The road deterioration level determination unit 304 calculates the IRI based on the acceleration information generated by the sensor 26 of the imaging device 200. Then, the road deterioration level determination unit 304 determines the level of road deterioration using the calculated IRI. Here, for example, the road deterioration level determination unit 304 may calculate the IRI by a method of converting the acceleration information into flatness of the road surface from the correlation between the acceleration information and the flatness of the road surface, and converting the converted flatness into the IRI from the correlation between the flatness and the IRI, and the road deterioration level determination unit 304 may calculate the IRI by another known method.

The road deterioration level determination unit 304 classifies levels of road deterioration according to the IRI calculated from the acceleration information. The road deterioration level determination unit 304 classifies levels of road deterioration into three levels of high, medium, and low according to the calculated IRI, for example.

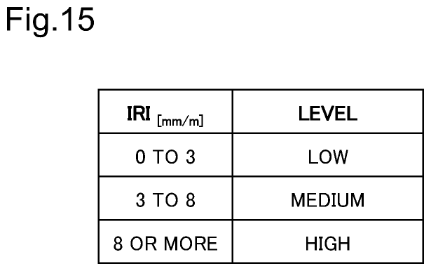

FIG. 15 is a table presenting an example of the relationship between an IRI and a road deterioration level in the third example embodiment. In the table of FIG. 15, the level of IRI is classified into three of low, medium, and high.

The road deterioration level determination unit 304 determines the level of the detected road deterioration with reference to, for example, a table as illustrated in FIG. 15.

The display control unit 305 displays a detection result of road deterioration together with the determined road deterioration level.

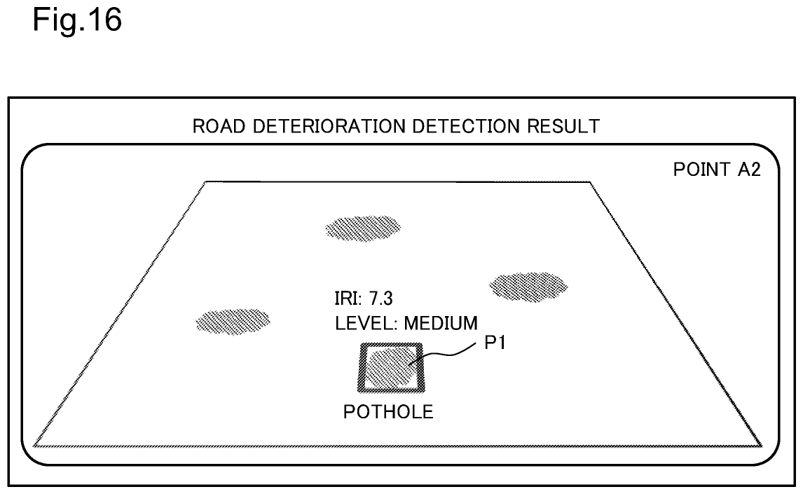

FIG. 16 is a view illustrating an output example of a detection result of road deterioration in the third example embodiment.

For example, the display control unit 305 displays an image indicating the presence of road deterioration at a position of the puddle where the road deterioration is detected in an image in which the road is captured, for example, the type of the road deterioration, and the IRI or the road deterioration level of the road deterioration. The display control unit 305 may display both the IRI and the road deterioration level of road deterioration. In the example of FIG. 16, the periphery of the puddle P1 determined to be a pothole is emphasized with a rectangular frame indicating road deterioration, and the type “pothole”, the IRI “7.3”, and the road deterioration level “medium” are displayed. Note that instead of displaying the road deterioration level with characters, the display control unit 305 may display a rectangular frame indicating road deterioration and a puddle in a color corresponding to the road deterioration level.

Next, the operation of the third example embodiment will be described.

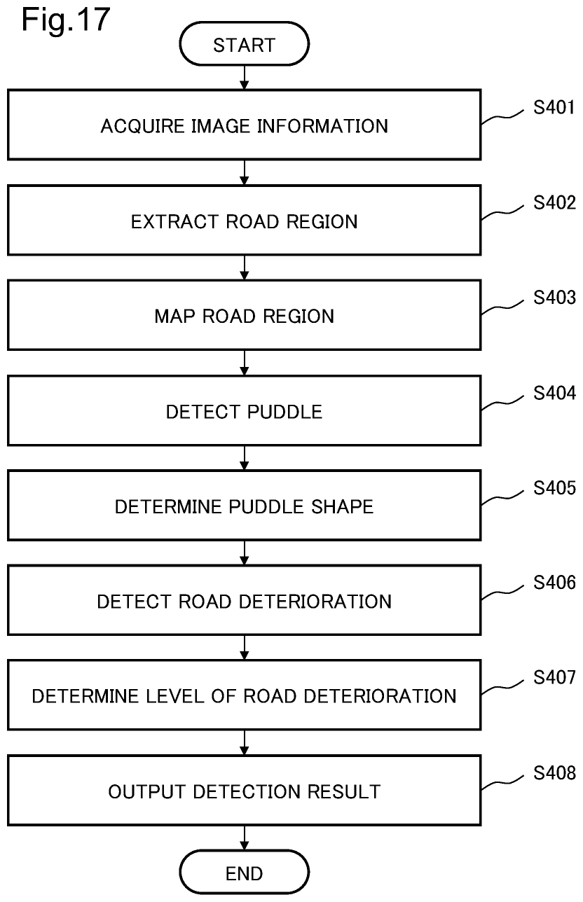

FIG. 17 is a flowchart presenting the road deterioration diagnostic processing in the third example embodiment. In the road deterioration diagnostic processing of the third example embodiment, processing (steps S401 to S406) from acquisition of image information to detection of the type of road deterioration at each point is similar to the processing (steps S201 to S206) of the second example embodiment.

Next, the road deterioration level determination unit 304 determines the level of the detected road deterioration (step S407).

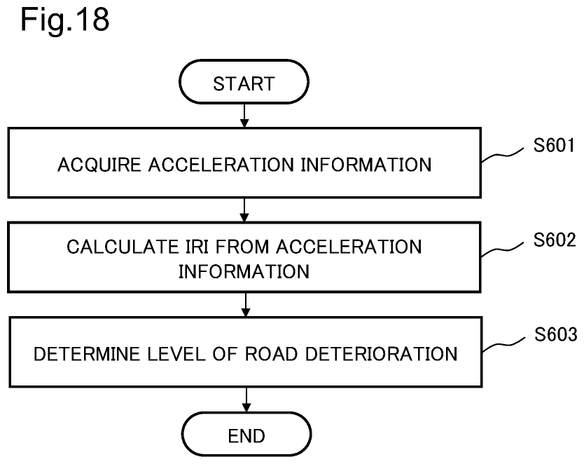

FIG. 18 is a flowchart presenting details of the road deterioration level determination processing (step S407) in the third example embodiment.

The road deterioration level determination unit 304 acquires, from the storage unit 301, acceleration information associated with an image in which road deterioration is detected (step S601).

The road deterioration level determination unit 304 calculates the IRI based on the acquired acceleration information (step S602).

The road deterioration level determination unit 304 determines the level of the detected road deterioration based on a reference table indicating the relationship between the IRI and the road deterioration level (step S603).

Next, the display control unit 305 displays a detection result of road deterioration together with the determined road deterioration level (step S408).

Thus, the operation of the third example embodiment is completed.

Next, effects of the third example embodiment will be described.

According to the third example embodiment, it is possible to grasp the level of road deterioration detected based on the shape of the puddle together with the road deterioration detected based on the shape of the puddle. This is because the road deterioration diagnostic device 310 determines the road deterioration level based on acceleration information and presents the road deterioration level together with the detected road deterioration.

### Fourth Example Embodiment

The fourth example embodiment will be described.

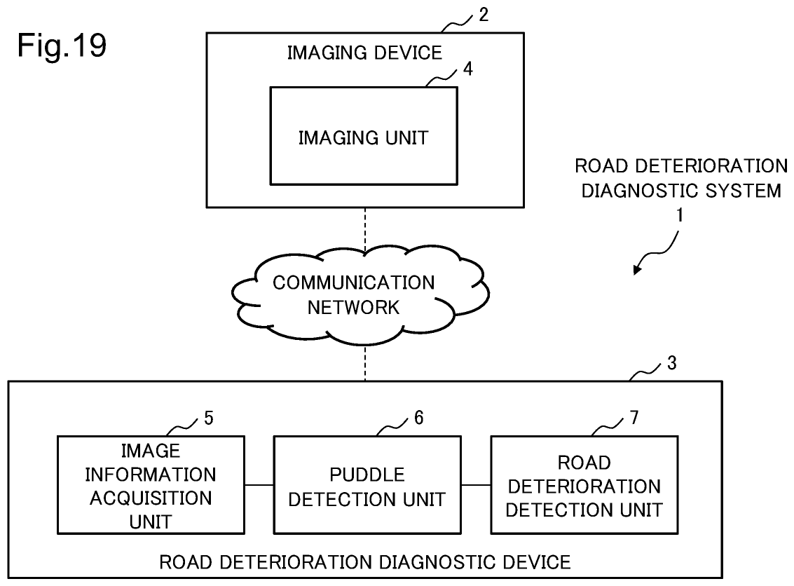

FIG. 19 is a block diagram illustrating an example of the configuration of the road deterioration diagnostic system 1 in the fourth example embodiment.

With reference to FIG. 19, the road deterioration diagnostic system 1 includes an imaging device 2 and a road deterioration diagnostic device 3. The imaging device 2 includes an imaging unit 4. The road deterioration diagnostic device 3 includes an image information acquisition unit 5, a puddle detection unit 6, and a road deterioration detection unit 7. The image information acquisition unit 5, the puddle detection unit 6, and the road deterioration detection unit 7 are example embodiments of an image information acquisition means, a puddle detection means, and a road deterioration detection means, respectively.

The image information acquisition unit 5 acquires an image in which a road is captured. For example, the image information acquisition unit 5 acquires, from the imaging device 2 via a communication network or the like, an image of a road captured by the imaging unit 4 of the imaging device 2 mounted on a vehicle.

The puddle detection unit 6 detects a puddle based on the acquired image. For example, the puddle detection unit 6 extracts a road from the acquired image using the Hough transform or the like, and detects a puddle in the extracted road using a known method such as image recognition.

The road deterioration detection unit 7 detects road deterioration based on the detected shape of a puddle. For example, the road deterioration detection unit 7 calculates a parameter related to the shape such as a ratio of vertical and horizontal lengths of the detected puddle, determines the shape of the puddle based on the parameter, and detects road deterioration based on the shape.

Next, effects of the fourth example embodiment will be described.

According to the fourth example embodiment, road deterioration can be accurately detected at low cost. This is because the road deterioration diagnostic device 3 detects a puddle based on an image in which a road is captured, and detects road deterioration based on the shape of the detected puddle.

(Hardware Configuration)

In each of the above-described example embodiments, each component of each device (the imaging devices 20 and 200, the road deterioration diagnostic devices 30, 300, and 310, and the like) indicates a block of a functional unit. Some or all of the components of each device may be achieved by a discretionary combination of the computer 500 and a program.

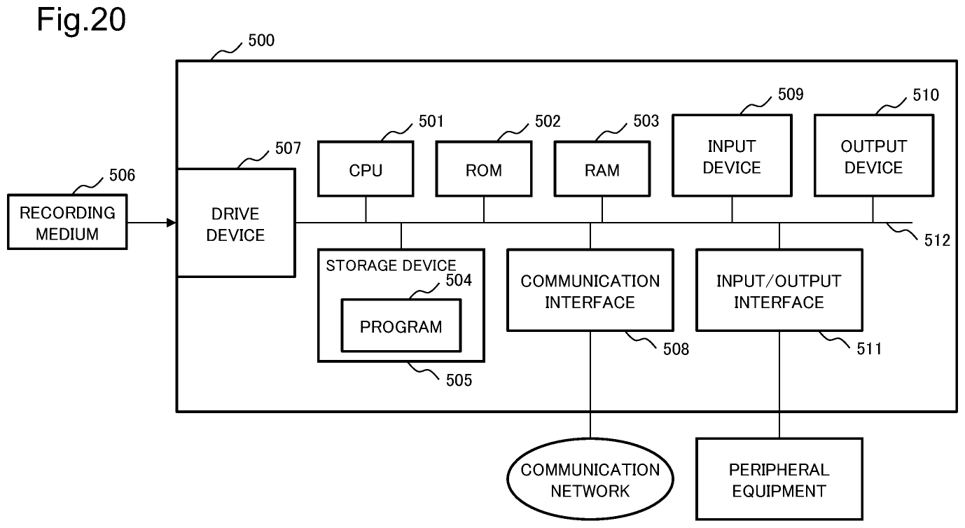

FIG. 20 is a block diagram illustrating an example of the hardware configuration of the computer 500. With reference to FIG. 20, the computer 500 includes, for example, a central processing unit (CPU) 501, a read only memory (ROM) 502, a random access memory (RAM) 503, a program 504, a storage device 505, a drive device 507, a communication interface 508, an input device 509, an output device 510, an input/output interface 511, and a bus 512.

The program 504 includes an instruction for achieving each function of each device. The program 504 is stored in advance in the ROM 502, the RAM 503, and the storage device 505. The CPU 501 achieves each function of each device by executing an instruction included in the program 504. For example, by executing an instruction included in the program 504, the CPU 501 of the road deterioration diagnostic device 300 achieves the functions of the image information acquisition unit 302, the weather information acquisition unit 303, the puddle detection unit 32, the road deterioration detection unit 33, and the display control unit 34. For example, the RAM 503 of the road deterioration diagnostic device 300 may store data of the storage unit 301.

The drive device 507 performs reading and writing on the recording medium 506. The communication interface 508 provides an interface with a communication network. The input device 509 is, for example, a mouse, a keyboard, or the like, and receives an input of information from the operator or the like. The output device 510 is, for example, a display, and outputs (displays) information to the operator or the like. The input/output interface 511 provides an interface with peripheral equipment. The bus 512 connects those components of the hardware. Note that the program 504 may be supplied to the CPU 501 via a communication network, or may be stored in the recording medium 506 in advance, read by the drive device 507, and supplied to the CPU 501.

Note that the hardware configuration illustrated in FIG. 20 is an example, and other components may be added or some components need not be included.

There are various modifications of the achievement method of each device. For example, each device may be achieved by a discretionary combination of a computer and a program different for each component. A plurality of components included in each device may be achieved by a discretionary combination of a computer and a program.

Also, some or all of the components of each device may be achieved by a general-purpose or special-purpose circuitry including a processor, or a combination thereof. These circuitries may be configured by a single chip or may be configured by a plurality of chips connected via the bus. Some or all of the components of each device may be achieved by a combination of the above-described circuitry and a program.

When some or all of the components of each device are achieved by a plurality of computers, circuitries, and the like, the plurality of computers, circuitries, and the like may be centralized or decentralized.

The road deterioration diagnostic devices 30, 300, and 310 may be disposed in the vehicle 40, or may be disposed in a place different from the vehicle 40 and connected to the imaging devices 20 and 200 via a communication network.

While the present disclosure has been particularly shown and described with reference to exemplary embodiments thereof, the present disclosure is not limited to these embodiments. It will be understood by those of ordinary skill in the art that various changes in form and details may be made therein without departing from the spirit and scope of the present disclosure as defined by the claims. The configurations in the example embodiments can be combined with one another without departing from the scope of the present disclosure.

This application is based upon and claims the benefit of priority from Japanese patent application No. 2020-058070, filed on Mar. 27, 2020, the disclosure of which is incorporated herein in its entirety by reference.

### REFERENCE SIGNS LIST

1, 100, 110 road deterioration diagnostic system
2, 20, 200 imaging device
3, 30, 300, 310 road deterioration diagnostic device
4, 21 imaging unit
5, 31, 302 image information acquisition unit
6, 32 puddle detection unit
7, 33 road deterioration detection unit
22 time acquisition unit
23 point acquisition unit
24, 301 storage unit
25 transmission unit
26 sensor
34, 305 display control unit
40 vehicle
303 weather information acquisition unit
304 road deterioration level determination unit
500 computer
501 CPU
502 ROM
503 RAM
504 program
505 storage device
506 recording medium
507 drive device
508 communication interface
509 input device
510 output device
511 Input/output interface
512 bus

What is claimed is:

1. A road deterioration diagnostic device comprising:
a memory storing instructions; and
one or more processors configured to execute the instructions to:
acquire an image in which a road is captured;
detect a puddle based on the image; and
detect road deterioration based on a shape of the puddle.

2. The road deterioration diagnostic device according to claim 1, wherein
the one or more processors are further configured to execute the instructions to:
determine that a pothole has occurred at a position of the puddle, in a case that a shape of the puddle has a ratio that is equal to or less than a first threshold, the ratio being a ratio of a length in a long direction to a length in a short direction.

3. The road deterioration diagnostic device according to claim 1, wherein
the one or more processors are further configured to execute the instructions to:
determine that a rut has occurred at a position of the puddle, in a case that a shape of the puddle has a ratio that is equal to or greater than a second threshold, the ratio being a ratio of a length in a long direction to a length in a short direction.

4. The road deterioration diagnostic device according to claim 1, wherein
the one or more processors are further configured to execute the instructions to:
acquire the image captured in a time period at a capturing point having rainfall, the time period having a predetermined length after a predetermined time from rainfall end time.

5. The road deterioration diagnostic device according to claim 4, wherein
the one or more processors are further configured to execute the instructions to:
acquire the image at a capturing point where duration of the rainfall or an accumulated rainfall amount in a predetermined period up to the rainfall end time is equal to or more than a predetermined value.

6. The road deterioration diagnostic device according to claim 1, wherein
the one or more processors are further configured to execute the instructions to:
determine a road deterioration level based on acceleration information associated with the image; and
display a type of the determined road deterioration and a road deterioration level in association with each other.

7. A road deterioration diagnostic system comprising:
the road deterioration diagnostic device according to claim 1; and
an imaging device that transmits, to the road deterioration diagnostic device, the image in which the road is captured.

8. A road deterioration diagnostic method comprising:
acquiring an image in which a road is captured;
detecting a puddle based on the image; and
detecting road deterioration based on a shape of the puddle.

9. A non-transitory computer-readable recording medium that stores a program that causes a computer to execute:
processing of acquiring an image in which a road is captured;
processing of detecting a puddle based on the image; and
processing of detecting road deterioration based on a shape of the puddle.

10. (canceled)
